(19) United States
(12) Patent Application Publication
(10) Pub. No.: US 2017/0166843 A1
(43) Pub. Date: Jun. 15, 2017

(54) PROCESS OF MAKING A LIQUID LAUNDRY DETERGENT COMPOSITION

(71) Applicant: The Procter & Gamble Company, Cincinnati, OH (US)

(72) Inventors: Lucia FERNANDEZ MARTINEZ, Brussels (BE); Nigel Patrick SOMERVILLE ROBERTS, Newcastle upon Tyne (GB); Alan Thomas BROOKER, Newcastle upon Tyne (GB); Laurens BEELEN, Mechelen (BE); Sergio MARTIN-PRIETO, Brussels (BE)

(21) Appl. No.: 15/364,537

(22) Filed: Nov. 30, 2016

(30) Foreign Application Priority Data
Dec. 10, 2015 (EP) 15199375.5

(51) Int. Cl. C11D 11/00; C11D 3/20; C11D 1/22; C11D 1/29; C11D 17/04; C11D 3/22

(52) U.S. Cl. CPC C11D 11/0017; C11D 17/043; C11D 3/225; C11D 1/22; C11D 1/29; C11D 3/2068; C11D 3/2041

(57) ABSTRACT

A process of making a liquid laundry detergent composition suitable for use in a water-soluble unit dose article.

### FIELD OF THE INVENTION

The present disclosure relates to a process of making a liquid laundry detergent composition.

### BACKGROUND OF THE INVENTION

During manufacture of liquid laundry detergent compositions it is preferred to maintain a certain production speed, or throughput, in order to meet consumer demand. In order to achieve this, the composition cannot be too viscous otherwise it cannot be effectively manufactured and processed. The high viscous composition, for example compacted, low water compositions for use in water-soluble unit dose articles, cannot easily be pumped through the pipes and tanks, meaning that production rates are decreased, or large cumbersome pumps need to be used which require significant cost and space in the production facility.

If the viscosity is decreased by diluting the composition, this can negatively impact the performance of the composition and mean that the composition has a tendency to leak from the nozzles during filling of the composition into appropriate receptacles. The viscosity can be adjusted by the addition of rheology modifiers however, it is preferred to not include rheology modifiers if possible as this impacts available formulation space for other cleaning or benefit actives.

Alternatively, if the diameter of the nozzle aperture is decreased to prevent leaking this can negatively affect the production speed and throughput.

Therefore, there is a need for a process to efficiently manufacture liquid laundry detergent compositions suitable for use in water-soluble unit dose articles, wherein the use of rheology modifiers are minimized whilst efficient production rates are maintained.

It was surprisingly found that the present invention overcame this problem.

### SUMMARY OF THE INVENTION

The present disclosure relates to a process of making a liquid laundry detergent composition suitable for use in a water-soluble unit dose article, wherein the process comprises the steps of:
a. preparing a particulate composition;
b. preparing a first liquid composition by adding the particulate composition from step a) to an alcohol;
c. prepare a second liquid composition comprising an anionic surfactant;
d. add the first composition to the second composition to form the detergent composition, wherein the detergent composition comprises between 5% and 25% by weight of the composition of particles;
e. transferring the detergent composition of step d) through an aperture having a cross-sectional area between 2 mm² and 30 mm² into a receptacle.

### DETAILED DESCRIPTION OF THE INVENTION

### Process

The present disclosure relates to a process of making a liquid laundry detergent composition suitable for use in a water-soluble unit dose article. Water-soluble unit dose articles are described in more detail below.

The term ‘liquid laundry detergent composition’ refers to any laundry detergent composition comprising a liquid capable of wetting and treating fabric e.g., cleaning clothing in a domestic washing machine, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid laundry detergent composition can be used as a fully formulated consumer product, or may be added to one or more further ingredient to form a fully formulated consumer product. The liquid laundry detergent composition may be a ‘pre-treat’ composition which is added to a fabric, preferably a fabric stain, ahead of the fabric being added to a wash liquor.

The liquid laundry detergent composition can be used in a fabric hand wash operation or may be used in an automatic machine fabric wash operation.

The process comprises the steps of;
a. Preparing a particulate composition;
b. Preparing a first liquid composition by adding the particulate composition from step a) to an alcohol;
c. Prepare a second liquid composition comprising an anionic surfactant;
d. Add the first composition to the second composition to form the detergent composition, wherein the detergent composition comprises between 5% and 25% by weight of the composition of particles;
e. transferring the detergent composition of step d) through an aperture having a cross-sectional area between 2 mm² and 30 mm² into a receptacle.

Preferably, the detergent composition comprises less than 10% by weight of the detergent composition of a rheology modifier. The rheology modifier may be selected from non-polymeric or polymeric rheology modifiers. The rheology modifier may be a non-polymeric rheology modifier, preferably a crystallisable glyceride. The rheology modifier may be a polymeric rheology modifier, preferably a fibre based polymeric rheology modifier, more preferably a cellulose fibre-based rheology modifier. The rheology modifier may be selected from crystallisable glyceride, cellulose-fibre based rheology modifiers, TiO₂, silica and mixtures thereof.

Suitable rheology modifiers are preferably ingredients which impart a sufficient yield stress or low shear viscosity to stabilize the liquid laundry detergent composition independently from, or extrinsic from, any structuring effect of the detersive surfactants of the composition. Preferably, they impart to the laundry detergent composition a high shear viscosity at 20 sec-1 at 21° C. of from 1 to 1500 cps and a viscosity at low shear (0.05 sec-1 at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1-1 to 25-1 in 3 minutes time at 21° C.

The rheology modifier may be a polymeric crystalline, hydroxy-functional rheology modifier that comprises a crystallizable glyceride, preferably hydrogenated castor oil or “HCO”. HCO as used herein most generally can be any hydrogenated castor oil or derivative thereof, provided that it is capable of crystallizing in the non-polymeric crystalline, hydroxy-functional rheology modifier premix. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may be selected from: trihydroxystearin; dihydroxystearin; and mixtures thereof. The HCO may be processed in any suitable starting form, including, but not limited to those selected from solid, molten and mixtures thereof.

HCO of use in the present invention includes those that are commercially available. Non-limiting examples of commercially available HCO of use in the present invention include: THIXCIN® from Rheox, Inc. While the use of hydrogenated castor oil is preferred, any crystallisable glyceride can be used within the scope of the invention. Preferred crystallisable glyceride(s) have a melting point of from 40° C. to 100° C.

The rheology modifier may comprise a fibre-based rheology modifier. The rheology modifier may comprise a microfibrillated cellulose (MFC), which is a material composed of nanosized cellulose fibrils, typically having a high aspect ratio (ratio of length to cross dimension). Typical lateral dimensions are 1 to 100, or 5 to 20 nanometres, and longitudinal dimension is in a wide range from nanometres to several microns. For improved structuring, the microfibrillated cellulose preferably has an average aspect ratio (lid) of from 50 to 200,000, more preferably from 100 to 10,000. Microfibrillated cellulose can be derived from any suitable source, including bacterial cellulose, citrus fibers, and vegetables such as sugar beet, chicory root, potato, carrot, and the like.

The rheology modifier may be selected from the group consisting of titanium dioxide, tin dioxide, any forms of modified TiO₂, TiO₂ or stannic oxide, bismuth oxychloride or bismuth oxychloride coated TiO₂, silica coated TiO₂ or metal oxide coated TiO₂ and mixtures thereof.

Modified TiO₂ may comprise carbon modified TiO₂, metallic doped TiO₂ or mixtures thereof. Metallic doped TiO₂ may be selected from platinum doped TiO₂, Rhodium doped TiO₂.

The rheology modifier may comprise silica. Those skilled in the art will know suitable silica materials to use. The silica may comprise fumed silica.

a. Preparing a Particulate Composition

The process comprises preparing a particulate composition. By particulate composition we herein mean a solid composition comprising particles. It does not envisage compositions in which solids are dispersed within a liquid medium. Preferably, the particulate composition is free flowing.

The particulate composition may have a mean particle size distribution of between 40 microns and 200 micron and a d90 between 100 and 400 micron.

The particles may be any suitable particle. Preferably the particles comprise a fabric cleaning or care benefit agent. The particles may comprise between 10% and 100% by weight of the particles of the benefit agent. Individual particles may comprise between 10% and 100% by weight of the particle of a benefit agent. Individual particles may comprise benefit agent and a carrier. Suitable carriers include sulphate, carbonate, clay, starch, sugars, polyethylene glycol or a mixture thereof. Wherein the particle comprises a carrier, the benefit agent is comprised within the carrier, on the carrier, or a mixture thereof.

The benefit agent may be selected from polymers, surfactants, hueing dyes, chelants, enzymes or mixtures thereof.

The particulate composition may comprise a polymer, preferably a cellulosic polymer, more preferably a cellulosic polymer selected from hydroxyethylcellulose, carboxymethylcellulose or a mixture thereof.

The hydroxyethylcellulose may comprise a hydrophobically modified hydroxyethylcellulose. By ‘hydrophobically modified’, we herein mean that one or more hydrophobic groups are bound to the polymer backbone. The hydrophobic group may be bound to the polymer backbone via an alkylene group, preferably a C₁₋₆ alkylene group.

Preferably, the hydrophobic group is selected from linear or branched alkyl groups, aromatic groups, polyether groups, or a mixture thereof.

The hydrophobic group may comprise an alkyl group. The alkyl group may have a chain length of between C₈ and C₅₀, preferably between C₈ and C₂₆, more preferably between C₁₂ and C₂₂, most preferably between C₁₆ and C₂₀.

The hydrophobic group may comprise a polyalkylene glycol, preferably wherein the polalkylene glycol is selected from polyethylene glycol, polypropylene glycol, or a mixture thereof. The polyethylene glycol may comprise a copolymer comprising oxyethylene and oxypropylene units. The copolymer may comprise between 2 and 30 repeating units, wherein the terminal hydroxyl group of the polyalkylene glycol is preferably esterified or etherized. Preferably, the ester bond is formed with an acid selected from a C₅₋₅₀ carboxylic acid, preferably C₈₋₂₆ carboxylic acid, more preferably C₁₆₋₂₀ carboxylic acid, and wherein the ether bond is preferably formed with a C₅₋₅₀ alcohol, more preferably C₈₋₂₆ alcohol, most preferably a C₁₆₋₂₀ alcohol.

The hydroxyethyl cellulose may be derivatised with trimethyl ammonium substituted epoxide. The polymer may have a molecular weight of between 100,000 and 800,000 daltons.

The hydroxyethyl cellulose may have repeating substituted anhydroglucose units that correspond to the general Structural Formula I as follows:

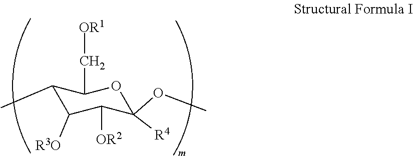

wherein:
a. m is an integer from 20 to 10,000
b. Each R4 is H, and R¹, R², R³ are each independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, and

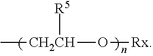

Preferably, R¹, R², R³ are each independently selected from the group consisting of: H; C₁-C₄ alkyl;

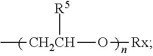

and mixtures thereof;

wherein:

n is an integer selected from 0 to 10 and

Rx is selected from the group consisting of: H;

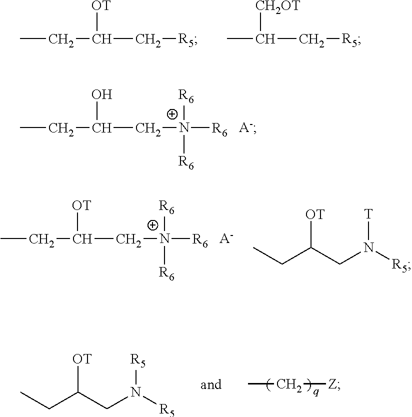

preferably Rx has a structure selected from the group consisting of: H;

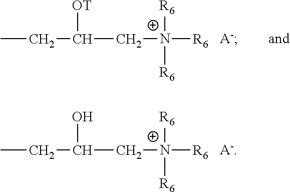

wherein A⁻ is a suitable anion. Preferably, A⁻ is selected from the group consisting of: Cl⁻, Br⁻, I⁻, methylsulfate, ethylsulfate, toluene sulfonate, carboxylate, and phosphate;
Z is selected from the group consisting of carboxylate, phosphate, phosphonate, and sulfate.
q is an integer selected from 1 to 4;
each R₅ is independently selected from the group consisting of: H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, and OH. Preferably, each R₅ is selected from the group consisting of: H, C₁-C₃₂ alkyl, and C₁-C₃₂ substituted alkyl. More preferably, R₅ is selected from the group consisting of H, methyl, and ethyl.
Each R₆ is independently selected from the group consisting of: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted alkylaryl. Preferably, each R₆ is selected from the group consisting of: H, C₁-C₃₂ alkyl, and C₁-C₃₂ substituted alkyl.
Each T is independently selected from the group: H,

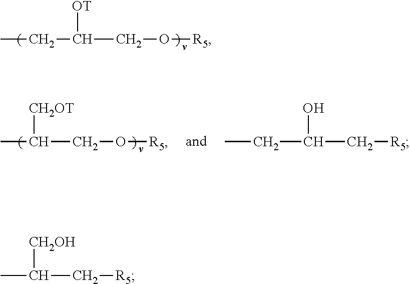

wherein each v in said polysaccharide is an integer from 1 to 10. Preferably, v is an integer from 1 to 5. The sum of all v indices in each Rx in said polysaccharide is an integer from 1 to 30, more preferably from 1 to 20, even more preferably from 1 to 10. In the last

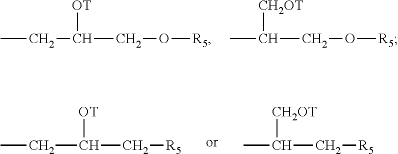

group in a chain, T is always an H.

Alkyl substitution on the anhydroglucose rings of the polymer may range from 0.01% to 5% per glucose unit, more preferably from 0.05% to 2% per glucose unit, of the polymeric material.

The hydroxyethylcellulose may be lightly cross-linked with a dialdehyde, such as glyoxal, to prevent forming lumps, nodules or other agglomerations when added to water at ambient temperatures.

The polymers of Structural Formula I likewise include those which are commercially available and further include materials which can be prepared by conventional chemical modification of commercially available materials. Commercially available cellulose polymers of the Structural Formula I type include those with the INCI name Polyquaternium 10, such as those sold under the trade names: Ucare Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name: Celquat H200 and Celquat L-200, available from National Starch and Chemical Company, Bridgewater, N.J. Other suitable polysaccharides include hydroxyethyl cellulose or hydoxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200 by Amerchol Corporation, Edgewater N.J.

The carboxymethyl cellulose may have a degree of carboxymethyl substitution from 0.5 to 0.9 and a molecular weight from 100,000 Da to 300,000 Da.

The carboxymethyl cellulose may have a degree of substitution (DS) of from 0.01 to 0.99 and a degree of blockiness (DB) such that either DS+DB is of at least 1.00 or DB+2DS-DS² is at least 1.20. The substituted carboxymethyl cellulose can have a degree of substitution (DS) of at least 0.55. The carboxymethyl cellulose can have a degree of blockiness (DB) of at least 0.35. The substituted cellulosic polymer can have a DS+DB, of from 1.05 to 2.00.

The first polymer may comprise a polyester terephthalate backbone grafted with one or more anionic groups. Suitable polymers have a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

b. Preparing a First Liquid Composition

A first liquid composition is prepared by adding the particulate composition from step a) to an alcohol.

Any suitable mixing means may be used. Preferably the alcohol and the particulate composition are mixed using a Dynamic Mixer, a static mixer or a combination thereof.

A dynamic mixer is any device that imparts shear on the composition. This includes gear pumps, colloid mills, homogenizers, and other such devices, or mixtures thereof.

Static Mixers are in-line units with no moving parts. The mixer is usuallyconstructed of a series of stationary, rigid elements that form intersecting channels to split, rearrange and combine component streams resulting in one homogeneous stream.

Koch engineering for example has the following models and types that can be utilized, such as SMV turbulent flow static mixers, SMX laminar flow static mixer, SMXL heat transfer enhancement static mixer, SMF static mixer, SMVP plug flow reactor mixer. Preferred in-line mixer is the SMX laminar flow static mixer due to its higher shear conditions.

Preferably, the particulate composition is added to the alcohol. Alternatively, the alcohol may be added to the particulate composition.

Preferably, the first liquid composition comprises between 50% and 100%, more preferably between 65% and 95% by weight of the first composition of the particulate composition. The first composition may comprise between 50% and 100%, more preferably between 65% and 95% by weight of the first composition of the benefit agent. The first composition may comprise between 50% and 100%, more preferably between 65% and 95% by weight of the first composition of the polymer.

The first composition may comprise between 40% and 80% by weight of the first composition of the alcohol.

The alcohol preferably has a molecular weight of between 20 and 400 and an eRH of between 50% and 80% preferably between 52% and 75% at 20° C. as measured via the alcohol eRH test described herein.

The alcohol eRH test comprises the steps of preparing a solution of 80% alcohol in deionised water, followed by adding this to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

By ‘alcohol’ we herein mean either a single compound or a mixture of compounds that when taken together collectively each have a molecular weight of between 20 and 400 and an overall eRH of the compound or mixture of between 50% and 80% at 20° C. as measured via the eRH test. Without wishing to be bound by theory, an alcohol is any compound comprising at least one OH unit, preferably polyols and diols, more preferably diols. Preferred diols included glycols.

Preferably, the alcohol may be selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, propylene glycol monopropyl ether, tripropylene glycol and mixtures thereof.

More preferably, the alcohol may be selected from the group comprising ethylene glycol, 1,2 propanediol, 2,3-butane diol, 1,3 butanediol, triethylene glycol, polyethylene glycol, glycerol formal dipropylene glycol, polypropylene glycol, dipropylene glycol n-butyl ether, and mixtures thereof.

Even more preferably the alcohol is selected from the group comprising 1,2 propanediol, dipropylene glycol, polypropylene glycol, 2,3-butane diol, dipropylene glycol n-butyl ether and mixtures thereof.

Most preferably the alcohol may be selected from the group comprising 1,2 propanediol, dipropylene glycol, polypropylene glycol, dipropylene glycol n-butyl ether and mixtures thereof.

c. Preparing a Second Liquid Composition

A second liquid composition is prepared comprising an anionic surfactant. The second composition may comprise other conventional laundry detergent ingredients.

The second composition may comprise between 10% and 50%, preferably between 15% and 45% by weight of the second composition of the anionic surfactant.

Preferably, the anionic surfactant is selected from linear alkylbenzene sulphonate, alkoxylated alkyl sulphate or mixtures thereof.

The anionic surfactant may be selected from linear alkybenzene sulphonate, alkoxylated alkyl sulphate, fatty acid or mixtures thereof.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear.

The alkoxylated alkyl sulphate anionic surfactant may be a C₁₀-C₁₈ alkyl ethoxy sulfate (AEₓS) wherein x is an average degree of ethoxylation of from 0.5 to 30, preferably between 1 and 10, more preferably between 1 and 5.

The term ‘fatty acid’ includes fatty acid or fatty acid salts. The fatty acids are preferably carboxylic acids which are often with a long unbranched aliphatic tail, which is either saturated or unsaturated. Suitable fatty acids include ethoxylated fatty acids. Suitable fatty acids or salts of the fatty acids for the present invention are preferably sodium salts, preferably C₁₂-C₁₈ saturated and/or unsaturated fatty acids more preferably C₁₂-C₁₄ saturated and/or unsaturated fatty acids and alkali or alkali earth metal carbonates preferably sodium carbonate.

Preferably the fatty acids are selected from the group consisting of lauric acid, myristic acid, palmitic acid, stearic acid, topped palm kernel fatty acid, coconut fatty acid and mixtures thereof.

d. Add the First Composition to the Second Composition to Form the Detergent Composition

The first composition is added to the second to form the detergent composition. The first and second compositions can be mixed using any suitable means. Preferably, the first and second compositions are mixed using a Dynamic Mixer, a static mixer or a combination thereof, however, any suitable mixing device may be used.

A dynamic mixer is any device that imparts shear on the composition. This includes gear pumps, colloid mills, homogenizers, and other such devices, or mixtures thereof.

Static Mixers are in-line units with no moving parts. The mixer is usually constructed of a series of stationary, rigid elements that form intersecting channels to split, rearrange and combine component streams resulting in one homogeneous stream.

Koch engineering for example has the following models and types that can be utilized, such as SMV turbulent flow static mixers, SMX laminar flow static mixer, SMXL heat transfer enhancement static mixer, SMF static mixer, SMVP plug flow reactor mixer. Preferred in-line mixer is the SMX laminar flow static mixer due to its higher shear conditions.

Preferably, the first composition is added to the second composition at a weight ratio of the first composition to the second composition of between 1:5 to 1:1.

The detergent composition comprises between 5% and 25% by weight of the composition of particles, preferably, the detergent composition comprises between 6% and 20%, preferably between 7% and 18% by weight of the composition of particles. Those skilled in the art will know how to formulate the composition to achieve this.

e. transferring the Detergent Composition of Step d) Through an Aperture

The detergent composition made in step d is transferred through an aperture into a receptacle. The aperture has a cross-sectional area between 2 mm² and 30 mm². The aperture may be circular or non-circular in shape. The aperture may be circular and have a diameter of between 2 mm and 3.5 mm, preferably between 2.5 mm and 3 mm.

Preferably the aperture is comprised within a nozzle but may be comprised within any suitable device for allowing the detergent composition to be placed within the receptacle.

The receptacle may be any suitable receptacle. Preferably the receptacle is a water-soluble unit dose article. Water-soluble unit dose articles are described in more detail below.

Preferably the receptacle is an open water-soluble unit dose article comprising a water-soluble film which has been shaped in a mould to form an open compartment. Preferably, the open compartment is closed by the addition of a second film over the opening which is then sealed to the first film.

### Water-Soluble Unit Dose Article

The water-soluble unit dose article comprises at least one water-soluble film shaped such that the unit-dose article comprises at least one internal compartment surrounded by the water-soluble film. The at least one compartment comprises the liquid laundry detergent composition. The water-soluble film is sealed such that the liquid laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

Of the total PVA resin content in the film described herein, the PVA resin can comprise about 30 to about 85 wt% of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film.

Suitable levels include, but are not limited to, 1 to 5000 ppm, or even 100 to 2500 ppm, or even 250 to 2000 rpm.

The unit dose article may comprise at least two compartments and the liquid laundry detergent composition is present in at least one compartment. The liquid laundry detergent composition may be present in a first compartment and a cellulase is present in a second compartment.

### Method of Use

The composition or unit dose article of the present invention can be added to a wash liquor to which laundry is already present, or to which laundry is added. It may be used in an washing machine operation and added directly to the drum or to the dispenser drawer. The washing machine may be an automatic or semi-automatic washing machine. It may be used in combination with other laundry detergent compositions such as fabric softeners or stain removers. It may be used as pre-treat composition on a stain prior to being added to a wash liquor.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

The following compositions were prepared as follows;

TABLE 1

| | Weight in grams | | |
|---|---|---|---|
| | Batch 1 | Batch 2 | Batch 3 |
| First liquid composition containing | 0 | 100 | 300 |
| hydrophobically modified | | | |
| hydroxymethylcellulose and | | | |
| carboxymethylcellulose and alcohol, | | | |
| wherein a particulate composition | | | |
| comprising hydrophobically modified | | | |
| hydroxyethylcellulose and | | | |
| carboxymethylcellulose was added | | | |
| to the alcohol | | | |
| Second liquid composition | 1000 | 900 | 700 |
| comprising anionic surfactant | | | |

Batch 3 was made according to the process of the present invention. Batch 1 was made using different proportions than required for the invention in which the first composition was not made and batch 2 was used different proportions of the ingredients mentioned in this case.

The compositions were prepared using an IKA EUROSTAR 200 with a 10cm diameter impeller and mixed at 250rpm. Ingredients were weighed using a Mettler Toledo PB3002-S.

Viscosity was measured using Rheometer DHR 1 from TA instruments just after making. The Rheometer was used following the manufacturer's instructions and set as follows;
1 min equilibration at 0.05 s-1
Flow curve from 0.05 to 1200 mPa·s in 10 min
Temperature: 20 C
Gap: 1000 um

Results can be seen in Table 2;

TABLE 2

| | cPs @ 1000 s−1 | % of pass |
|---|---|---|
| Batch 1 | 180 | 0 |
| Batch 2 | 232 | 13.3 |
| Batch 3 | 370 | 93.3 |

The liquid splash out of the nozzle was counted in 30 cycles. A PASS was recorded if the liquid went out straight from the nozzle. A NO PASS was recorded if the liquid took an angle when going out of the nozzle. Our success criterion was that 90% of the population should pass.

Measurement was made at a shear rate of 1000 s-1 as this corresponds to shear rate experienced during manufacture.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making a liquid laundry detergent composition suitable for use in a water-soluble unit dose article, wherein the process comprises the steps of:
a. preparing a particulate composition;
b. preparing a first liquid composition by adding the particulate composition from step a) to an alcohol;
c. prepare a second liquid composition comprising an anionic surfactant;
d. add the first composition to the second composition to form the detergent composition, wherein the detergent composition comprises between about 5% and about 25% by weight of the composition of particles;
e. transferring the detergent composition of step d) through an aperture having a cross-sectional area between about 2 mm² and about 30 mm² into a receptacle.

2. The process according to claim 1 wherein the receptacle is water-soluble.

3. The process according to claim 1 wherein the particulate composition comprises a polymer.

4. The process according to claim 3 wherein the polymer is a cellulosic polymer.

5. The process according to claim 4 wherein the cellulosic polymer is selected from hydrophobically modified hydroxyethylcellulose, carboxymethylcellulose, or a mixture thereof.

6. The process according to claim 3, wherein the first composition comprises between about 50% and about 100% by weight of the first composition of the polymer.

7. The process according to claim 6, wherein the first composition comprises between about 65% and about 95% by weight of the first composition of the polymer.

8. The process according to claim 1 wherein the second composition comprises between about 10% and about 50% by weight of the second composition of anionic surfactant.

9. The process according to claim 8 wherein the anionic surfactant is selected from linear alkylbenzene sulphonate, alkoxylated alkyl sulphate, or mixtures thereof.

10. The process according to claim 8 wherein the second composition comprises between about 15% and about 45% by weight of the second composition of anionic surfactant.

11. The process according to claim 1, wherein in step d), the first composition is added to the second composition at a weight ratio of the first composition to the second composition of between about 1:5 to about 1:1.

12. The process according to claim 1 wherein the alcohol has a molecular weight of between about 20 and about 400 and an eRH of between about 50% and about 80% at about 20° C. as measured via the alcohol eRH test described herein.

13. The process according to claim 1 wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, propylene glycol monopropyl ether, tripropylene glycol, and mixtures thereof.

14. The process according to claim 13 wherein the alcohol is selected from the group comprising 1,2 propanediol, dipropylene glycol, dipropylene glycol methyl ether, polypropylene glycol, 2,3-butane diol, dipropylene glycol n-butyl ether, and mixtures thereof.

15. The process according to claim 1 wherein the detergent composition comprises between about 5% and about 25% by weight of the composition of particles.

16. The process according to claim 15 wherein the detergent composition comprises between about 7% and about 18% by weight of the composition of particles.

17. The process according to claim 16, wherein the detergent composition comprises between about 5% and about 25% by weight of the composition of particles.

18. The process according to claim 17 wherein the detergent composition comprises between about 6% and about 20% by weight of the composition of particles.

19. The process according to claim 18 wherein the detergent composition comprises between about 7% and about 18% by weight of the composition of particles.

20. The process according to claim 1 wherein the detergent composition comprises less than about 10% by weight of the detergent composition of a rheology modifier.
